(19) United States
(12) Patent Application Publication
(10) Pub. No.: US 2011/0164032 A1
(43) Pub. Date: Jul. 7, 2011

(54) Three-Dimensional User Interface

(75) Inventor: Avraham Shadmi, Givat-Shmuel (IL)

(73) Assignee: PRIME SENSE LTD., Tel Aviv (IL)

(21) Appl. No.: 12/683,452

(22) Filed: Jan. 7, 2010

(51) Int. Cl. G06T 15/00; G09G 5/00

(52) U.S. Cl. 345/419; 345/156

(57) ABSTRACT

Methods and systems for interfacing a computer system are provided, which include capturing three-dimensional image maps over time of at least a part of a control element such as the body of a human subject, generating a three-dimensional representation of scene elements by driving a three-dimensional display with a second sequence of three-dimensional maps of scene elements. The two sequences of maps are correlated to detect a direction and speed of movement of the part of the body with respect to the scene elements. A relationship of the direction and speed of movement to at least one of the scene elements is established. A computer application is controlled according to the relationship that is established.

### BACKGROUND OF THE INVENTION

1. Field of the Invention

This invention relates to user interfaces for computerized systems. More particularly, this invention relates to user interfaces that have three-dimensional characteristics.

2. Description of the Related Art

Many different types of user interface devices and methods are currently available. Common tactile interface devices include the computer keyboard, mouse and joystick. Touch screens detect the presence and location of a touch by a finger or other object within the display area. Infrared remote controls are widely used, and “wearable” hardware devices have been developed, as well, for purposes of remote control.

Computer interfaces based on three-dimensional sensing of parts of the user's body have also been proposed. For example, PCT International Publication WO 03/071410, whose disclosure is incorporated herein by reference, describes a gesture recognition system using depth-perceptive sensors. A three-dimensional sensor provides position information, which is used to identify gestures created by a body part of interest. The gestures are recognized based on the shape of the body part and its position and orientation over an interval. The gesture is classified for determining an input into a related electronic device.

As another example, U.S. Pat. No. 7,348,963, whose disclosure is incorporated herein by reference, describes an interactive video display system, in which a display screen displays a visual image, and a camera captures three-dimensional information regarding an object in an interactive area located in front of the display screen. A computer system directs the display screen to change the visual image in response to the object.

A number of techniques are known for displaying three-dimensional images. An example is U.S. Pat. No. 6,857,746 to Dyner, which discloses a self-generating means for creating a dynamic, non-solid particle cloud by ejecting atomized condensate present in the surrounding air, in a controlled fashion, into an invisible particle cloud. A projection system consisting of an image generating means and projection optics, projects an image onto the particle cloud. Any physical intrusion, occurring spatially within the image region, is captured by a detection system and the intrusion information is used to enable real-time user interaction in updating the image.

### SUMMARY OF THE INVENTION

Systems of the sort noted above enable a user to control the appearance of a display screen without physical contact with any hardware by gesturing in an interactive spatial region that is remote from the display screen itself. Because conventional realizations of these systems provide two-dimensional displays, these systems are limited in their effectiveness when a displayed scene has extensive three-dimensional characteristics. In particular, when the user is manipulating objects on the screen, he generally cannot relate a location in the three-dimensional interactive spatial region to a corresponding location on the two-dimensional display.

An embodiment of the invention provides a method of interfacing a computer system, which is carried out by capturing a first sequence of three-dimensional maps over time of a control entity that is situated external to the computer system, generating a three-dimensional representation of scene elements by driving a three-dimensional display with a second sequence of three-dimensional maps of scene elements, and correlating the first sequence with the second sequence in order to detect a spatial relationship between the control entity and the scene elements. The method is further carried out by controlling a computer application responsively to the spatial relationship.

According to an aspect of the method, the spatial relationship is an overlap of the control entity in a frame of the first sequence with a scene element in a frame of the second sequence.

According to another aspect of the method, generating the three-dimensional representation includes producing an image of the scene elements in free space.

According to an additional aspect of the method, generating the three-dimensional representation includes extending a two-dimensional representation of the scene elements on a display screen to another representation having three perceived spatial dimensions.

One aspect of the method includes deriving a viewing distance of the human subject from the first sequence of three-dimensional maps, and adjusting the second sequence of three-dimensional maps according to the viewing distance.

Still another aspect of the method includes deriving a viewing angle of the human subject from the first sequence of three-dimensional maps, and adjusting the second sequence of three-dimensional maps according to the viewing angle.

Yet another aspect of the method includes correlating the first sequence with the second sequence in order to detect a direction and speed of movement of a part of the body or other control entity with respect to the scene elements and controlling a computer application responsively to the direction and speed of movement with respect to at least one of the scene elements.

Other embodiments of the invention provide computer software product and apparatus for carrying out the above-described method.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a schematic pictorial illustration of an interactive three-dimensional video display system which is constructed and operative in accordance with a disclosed embodiment of the invention;

FIG. 2 is a block diagram of functional components of a three-dimensional user interface, in accordance with a disclosed embodiment of the invention;

FIG. 3 is a side view of portions of the system shown in FIG. 1 operating under control of a user in accordance with a disclosed embodiment of the invention;

FIG. 4 is a sectional view of three-dimensional maps taken that are constructed in accordance with a disclosed embodiment of the invention;

FIG. 5 is a series of sections through composite three-dimensional maps in accordance with a disclosed embodiment of the invention; and

FIG. 6 is a flow chart of a method for interfacing a computerized system with a user employing three-dimensional sensing and three-dimensional scene projection, in accordance with a disclosed embodiment of the invention.

### DETAILED DESCRIPTION OF THE INVENTION

In the following description, numerous specific details are set forth in order to provide a thorough understanding of the various principles of the present invention. It will be apparent to one skilled in the art, however, that not all these details are necessarily always needed for practicing the present invention. In this instance, well-known circuits, control logic, and the details of computer program instructions for conventional algorithms and processes have not been shown in detail in order not to obscure the general concepts unnecessarily.

### System Architecture.

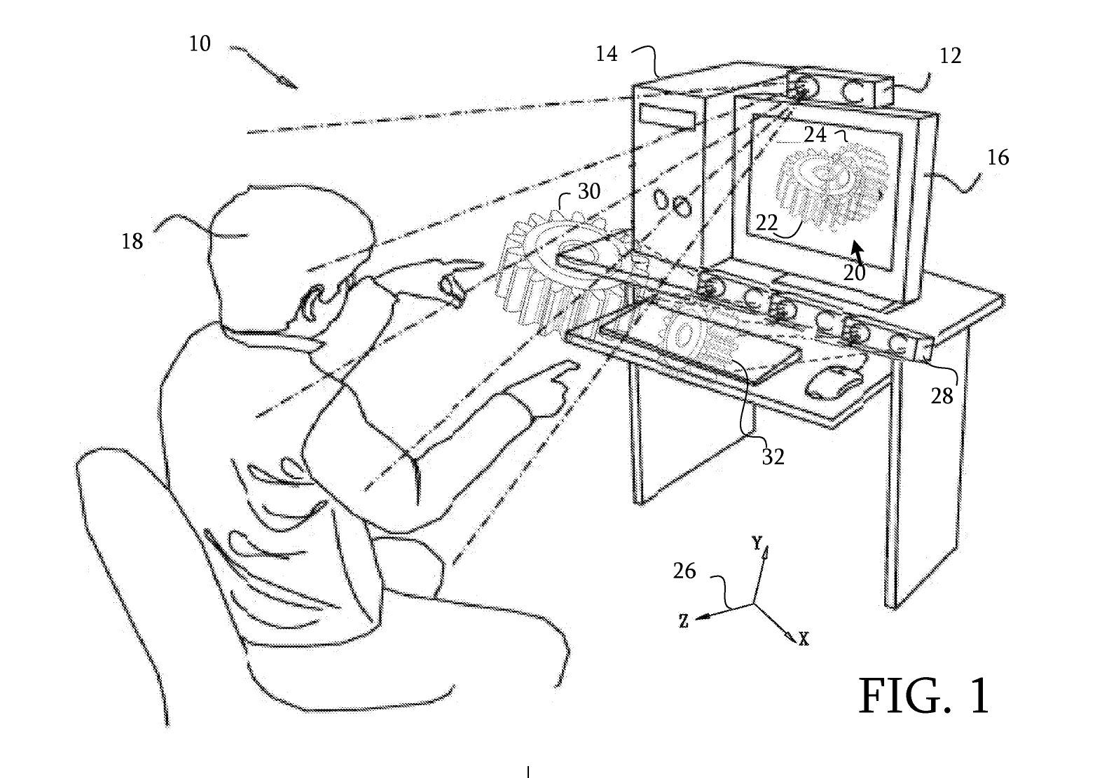

Turning now to the drawings, reference is initially made to FIG. 1, which is a schematic pictorial illustration of an interactive three-dimensional video display system 10, which is constructed and operative in accordance with a disclosed embodiment of the invention. The system 10 incorporates a sensing device 12, which is also known as a three-dimensional camera, and which captures information that includes the body (or at least parts of the body) of the user or other tangible entities wielded or operated by the user for controlling a computer application, all of which are sometimes referred to herein for convenience as “control entities”. In gaming applications, such control entities could include portions of objects being manipulated by the user, e.g., as swords, clubs, baseball bats, and tennis rackets. The arrangement described in commonly assigned application Ser. No. 12/352,622, filed Jan. 13, 2009, which is hereby incorporated by reference, is suitable for use in the system 10. While its principles are briefly described to facilitate understanding of the present invention, it should be noted that other known three-dimensional cameras may also be employed as the sensing device 12.

Information captured by the sensing device 12 is processed by a computer 14, which drives a display screen 16 accordingly.

The computer 14 typically comprises a general-purpose computer processor, which is programmed in software to carry out the functions described hereinbelow. The software may be downloaded to the processor in electronic form, over a network, for example, or it may alternatively be provided on tangible storage media, such as optical, magnetic, or electronic memory media. Alternatively or additionally, some or all of the image functions may be implemented in dedicated hardware, such as a custom or semi-custom integrated circuit or a programmable digital signal processor (DSP). Although the computer 14 is shown in FIG. 1, by way of example, as a separate unit from the sensing device 12, some or all of the processing functions of the computer may be performed by suitable dedicated circuitry within the housing of the sensing device 12 or otherwise associated with the sensing device 12.

The computer 14 executes image processing operations on data generated by the components of the system 10, including sensing device 12 in order to reconstruct three-dimensional maps of a user 18 and of scenes presented on the display screen 16. The term “three-dimensional map” refers to a set of three-dimensional coordinates representing the surface of a given object, e.g., a control entity.

In one embodiment, the sensing device 12 projects a pattern of spots onto the object and captures an image of the projected pattern. The computer 14 then computes the three-dimensional coordinates of points on the surface of the control entity by triangulation, based on transverse shifts of the spots in the pattern.

The display screen 16 presents a scene 20 comprising, by way of example, two partially superimposed objects 22, 24. The principles of the invention are equally applicable to one object, or any number of objects, which need not be superimposed. In two-dimensional projections of scenes of this sort, it may be difficult or even impossible to ascertain which of the objects is in the foreground and which in the background, even for a human observer. Conventionally, scene analysis algorithms may assist in such determinations; however they are computationally intense, and may require complex and expensive hardware in order to execute within an acceptable time frame.

In embodiments of the present invention, the system 10 is capable of producing a visual effect, in which the scene 20, as perceived by the user 18, has three-dimensional characteristics. The depth relationships of the objects 22, 24, i.e., their relative positions along Z-axis 26 of a reference coordinate system, are now easily resolved by the user 18. The need for automated scene analysis algorithms may be greatly reduced, or even eliminated altogether.

The system 10 includes a three-dimensional display module 28 for scene display, which is controlled by the computer 14. This subsystem produces a three-dimensional visual effect, which may appear to stand out from the display screen 16, or may constitute a three-dimensional image in free space. Several suitable types of known apparatus are capable of producing three-dimensional visual effects and can be incorporated in the three-dimensional display module 28. For example, the arrangement disclosed in the above-noted U.S. Pat. No. 6,857,746 is suitable. Alternatively, holographic projection units, or three-dimensional auto-stereoscopic displays, including spatially-multiplexed parallax displays may be used. An example of an auto-stereoscopic arrangement is known from U.S. Patent Application Publication No. 2009/0009593. Still other suitable embodiments of the three-dimensional display module 28 include view-sequential displays, and various stereoscopic and multi-view arrangements, including variants of parallax barrier displays. Further alternatively, the three-dimensional display module 28 may be realized as a specialized embodiment of the display screen 16. Commercially available display units of this type are available, for example, from Philips Co., Eindhoven, The Netherlands. In any case, the display module 28 extends a two-dimensional representation of a scene on a display screen to a display having three perceived spatial dimensions.

In the example of FIG. 1, a holographic projector embodies the three-dimensional display module 28. It is driven by the computer 14 to project a scene comprising the objects 22, 24 as holographic images 30, 32, respectively.

### Functional Components.

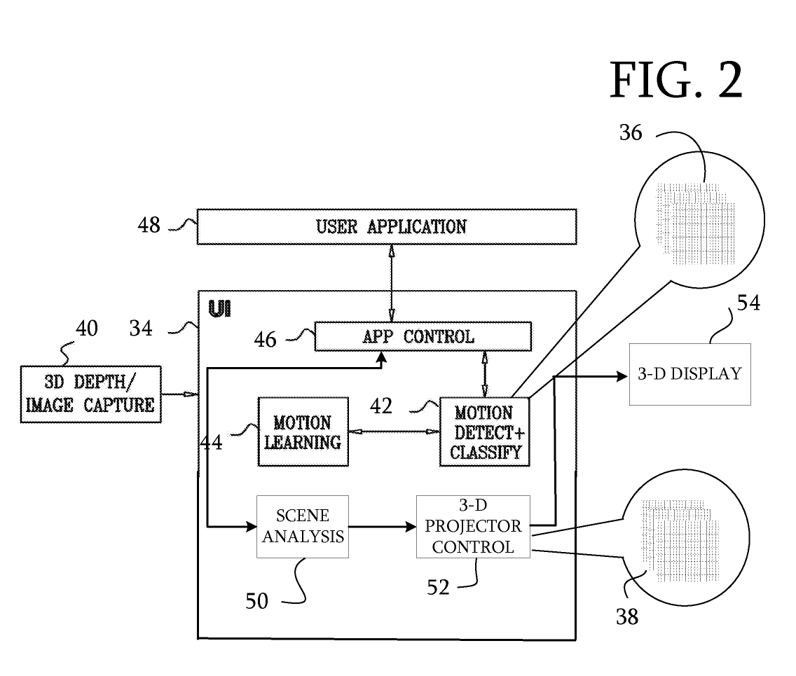

Reference is now made to FIG. 2, which is a block diagram of functional components of a three-dimensional user interface, in accordance with a disclosed embodiment of the invention. User interface 34 receives or constructs image depth maps 36, 38 based on the data generated by the sensing device 12 (FIG. 1).

The functional development of the image depth maps is indicated by three-dimensional image capture block 40 in FIG. 2. A motion detection and classification function 42 evaluates the image depth maps and identifies parts of the control entity. It detects and tracks the motion of these parts in order to decode and classify user gestures as the user interacts with three-dimensional projection of the scene 20 (FIG. 1). A motion learning function 44 may be used to train the system to recognize particular gestures for subsequent classification. The detection and classification function outputs information regarding the location and/or velocity (speed and direction of motion) of the detected control entity parts, and possibly decoded gestures, as well, to an application control function 46, which controls a user application 48 accordingly.

Scenes to be displayed are dispatched under control of the application control function 46. The three-dimensional aspects of the scenes are evaluated by a scene analysis function 50, which constructs three-dimensional scene depth maps 38 in a format acceptable to a three-dimensional projector control function 52. The projector control function 52 uses the scene depth maps 38 to drive a three-dimensional projector 54, e.g., three-dimensional display module 28 (FIG. 1), to produce three-dimensional images of the scene according to the technology employed. For example, in stereoscopic techniques that rely on a spectral shift to present an illusion of depth to the viewer, the magnitude of the spectral shift produced by the projector control function 52 may vary over the region represented by the three-dimensional scene map. There is a corresponding variation in the apparent Z-coordinates of the projected scene.

Preferably, the scene depth maps 38 are adjusted by the scene analysis function 50 to compensate for the viewing angle of the user with the display screen 16 and the viewing distance from the display screen 16 (FIG. 1), both of which can be readily derived from the image depth maps 36. The compensation techniques described in U.S. Patent Application Publication No. 2009/0009593, entitled “Three-dimensional Projection Display” may be applied for this purpose in the scene analysis function 50.

In some embodiments the scenes may be presented to the user interface 34 as three-dimensional scene maps that were developed off-line and are already in a format acceptable to the three-dimensional projector control function 52. In such embodiments the scene analysis function 50 may be limited to compensating the three-dimensional scene maps as noted above.

The image depth maps 36 and the scene depth maps 38 are produced dynamically. The framing rates obtainable are hardware dependent, but should be sufficiently high that the user is not distracted by jerky movements of the image and that latency in response of the user application 48 is acceptable. The framing rate of the image depth maps 36 and the scene depth maps 38 need not be identical. However it is desirable that both maps can be both be normalized to a common reference coordinate system. A framing rate of 30 FPS is suitable for many applications. However, in the case of applications involving rapid movements, e.g., a golf swing, higher framing rates, e.g., 60 FPS, may be required.

While analysis of motion and speed of a control entity is often analyzed, it should be noted that the mere overlap of a frame of the image depth maps 36 with a frame the scene depth maps 38 can be significant. An event of this sort may be used to stimulate the user application 48.

### Operation.

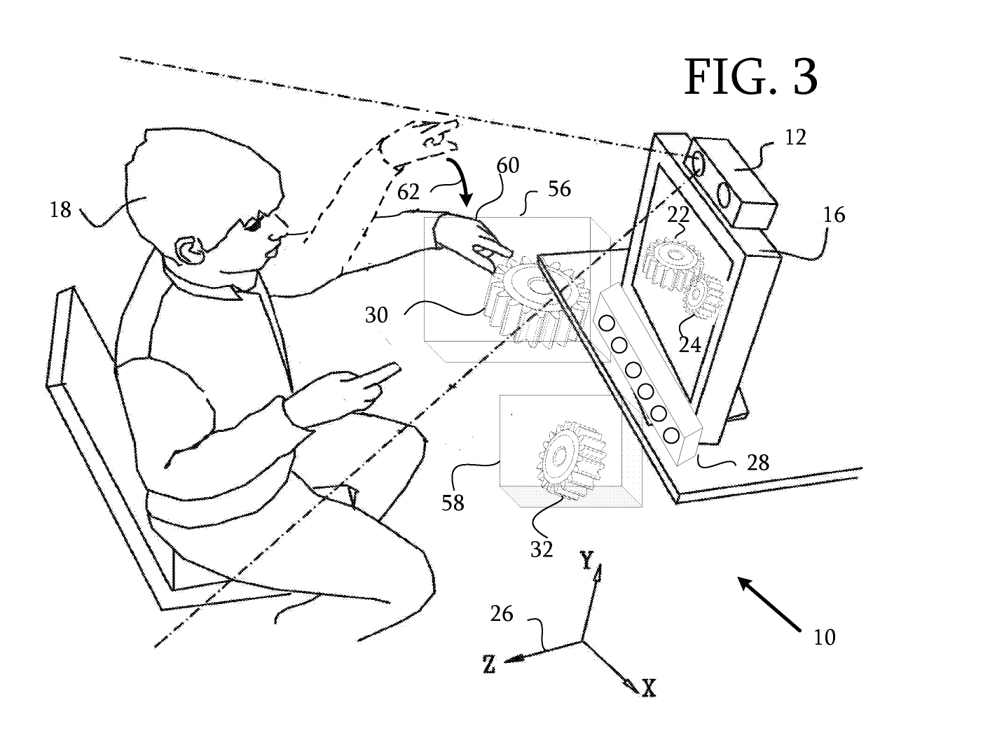

Reference is now made to FIG. 3, which is a side view of portions of the system 10 (FIG. 1) operating under control of the user 18 in accordance with a disclosed embodiment of the invention. The images 30, 32, which represent the objects 22, 24, lie within three-dimensional interaction regions 56, 58, respectively. The user 18 has completed a gesture with his left hand 60 in the general direction of the image 30, as indicated by an arrow 62. Hand 60 is recognized by the system 10 as a control entity part of interest that lies within the interaction region 56, using the teachings of the above-mentioned application Ser. No. 12/352,622. The gesture is further related by the system 10 to the object 22, as is explained in further detail hereinbelow. The relationship that is established with the object 22 and the gesture is gesture-specific. For example different relationships may be established according to the direction of motion being toward the object, away from the object, or simply passing through the interaction region 56. Additionally or alternatively, the relationship may depend on various linear or non-linear speed and directional characteristics, or rotatory motions of hand 60, e.g., axial or orbital motions. Indeed, gestures can comprise many combinations and sequences of transitional and rotatory motions, to establish many different relationships with a particular scene element. Gesture identification algorithms are known in the art, but are not discussed further as they are outside the scope of this disclosure.

The system 10 also appreciates that the hand 60 is outside the interaction region 58, and it therefore does not relate the gesture to the object 24.

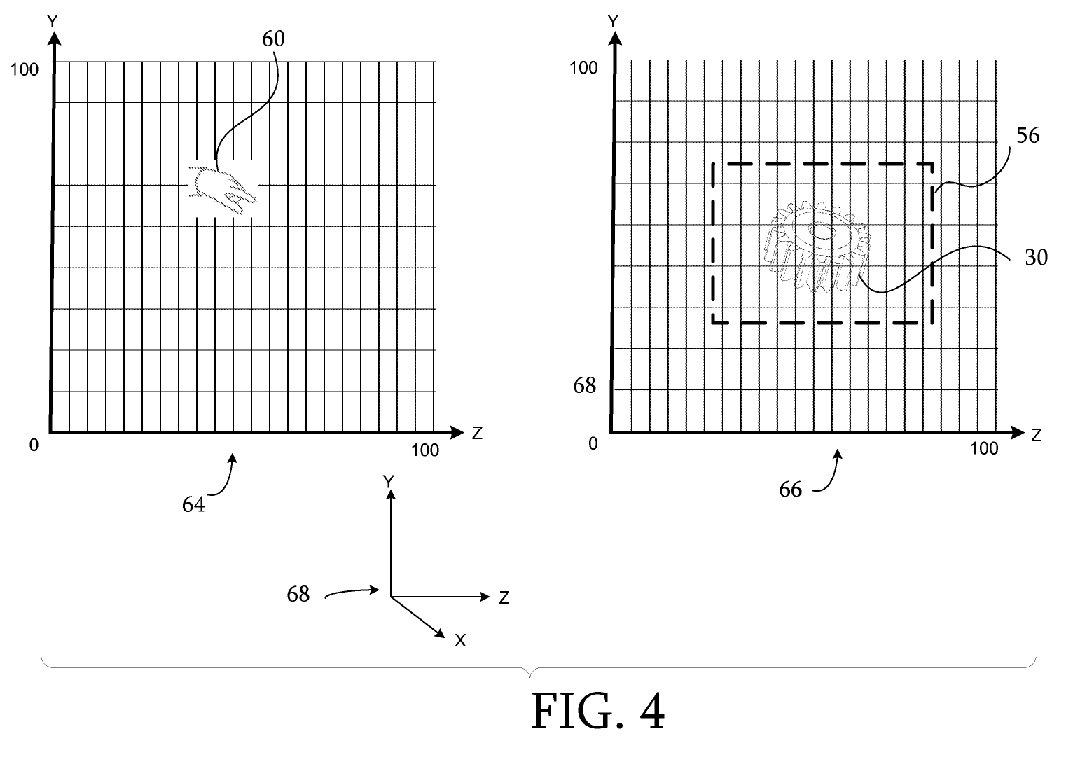

Reference is now made to FIG. 4, which is a sectional view of three-dimensional maps 64, 66 taken in the Y-Z plane that are constructed by the system 10 (FIG. 1) in accordance with a disclosed embodiment of the invention. The maps 64, 66 are instances of the image depth maps 36 and scene depth maps 38 (FIG. 4), respectively. The map 64 constitutes a snapshot of the surface coordinates of the hand 60 in the Y-Z plane at a particular moment in time.

Map 66 at the right side of FIG. 4 is a section in the Y-Z plane showing a three-dimensional projection of the scene 20 (FIG. 1), generated by the projector control function 52 (FIG. 2). The location of the image 30 (FIG. 3) and a section through the interaction region 56 are shown at the same moment of time with respect to a reference coordinate system 68.

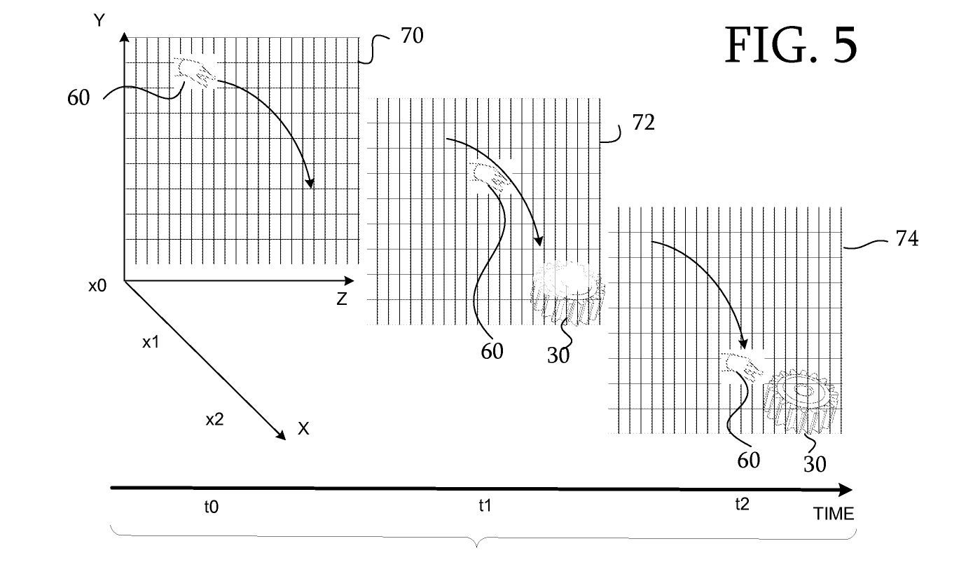

Reference is now made to FIG. 5, which is a series of sections through composite three-dimensional maps 70, 72, 74, formed by superimposing instances of the maps 64, 66 at times t0, t1, t2, and taken through X-coordinates x0, x1, x2, respectively. At time t0, the hand 60 is visible at the upper left of the map 70. At time t1, the hand 60 has descended to the right, approaching the image 30, of which a portion is visible in the lower right corner of the map 72. At time t3, the hand 60 has continued to descend to the right, approaching the image 30, which is now fully visible on the map 74.

The maps 70, 72, 74 are not normally displayed, but are provided to facilitate understanding of calculations carried out by the application control function 46 (FIG. 2) and provided to the user application 48. The application control function 46 is able to determine the motion vector of the hand 60, indicated by the curved arrows in the maps 70, 72, 74 for use by gesture identification routines.

An identified gesture, in conjunction with the known time-varying distance relationships between parts of a control entity, e.g., the hand 60 and particular scene elements such as image 30 or an interaction region, may constitute distinct stimuli for the user application 48 (FIG. 2), for example a video gaming applications.

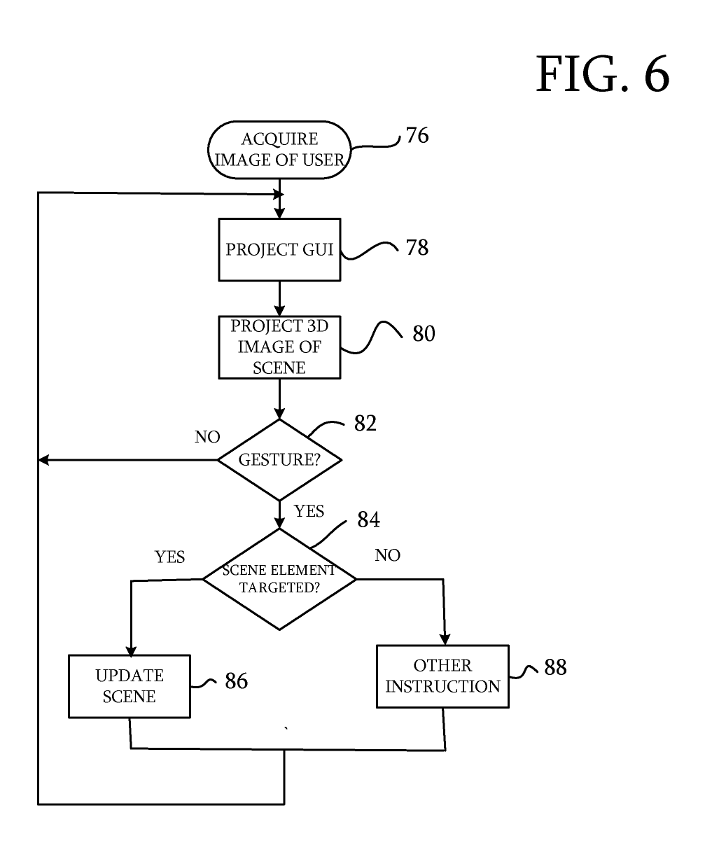

Reference is now made to FIG. 6, which is a flow chart of a method for interfacing a computerized system with a user employing three-dimensional sensing and three-dimensional projection in accordance with a disclosed embodiment of the invention. The process steps are described below in a particular linear sequence for clarity of presentation. However, it will be evident that many of them can be performed in parallel, asynchronously, or in different orders. The process can be performed, for example, by the system 10 (FIG. 1).

The process begins at initial step 76 in which an external image that includes the user's control entities is acquired.

Next, at step 78 a graphical user interface (GUI) to a user application is presented to a user. The user application may be a video game. It is assumed that the user application has been loaded, and that a three-dimensional sensing device is in operation. The sensing device can be any three-dimensional sensor or camera, provided that it generates data from which a three-dimensional image map of the user can be constructed.

Next, at step 80 a three-dimensional image of a current scene is projected for viewing by the user.

Control now proceeds to decision step 82, where the system awaits a gesture executed by of one or more of the user's control entities that is meaningful to the user application. This step is performed by iteratively analyzing three-dimensional data provided by the sensing device, for example by constructing a three-dimensional map as described above. Any gesture recognition algorithm may be employed to carry out decision step 82, so long as the system can relate the user gesture to a location of some scene element of interest.

If the determination at decision step 82 is negative, then control returns to step 78.

Otherwise, at decision step 84 it is determined if the gesture recognized in decision step 82 targets a particular scene element. This may be determined, for example, by recognizing that the gesture at least partly overlaps the coordinates of a known interaction region or the scene element itself. If the determination at decision step 84 is affirmative, then control proceeds to step 86. A control instruction is sent to the user application, which can be for any purpose, for example to update the scene, adjust audio volume, display characteristics, or even to launch another application in accordance with the gesture identified. For example, the downward and rightward directed gesture described with respect to FIG. 5 might correspond to an instruction to delete the scene element, while an upward and leftward gesture, in which the direction of the motion vector is reversed, could result in an instruction to visually emphasize the scene element. Many such combinations will occur to a developer of user applications. In either case, an updated scene results, which is then projected in subsequent iterations of the method.

If the determination at decision step 84 is negative, then control proceeds returns to step 88. Another type instruction is given that may or may not relate to the scene, or even the particular user application. For example the gesture may correspond to an instruction to the computer operating system, for example “close the user application”, “back up data”, and the like.

Control then returns to step 78. In practice the process iterates so long as the user application is active or some error occurs.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in th art upon reading the foregoing description.

1. A method of interfacing a computer system, comprising the steps of:
capturing a first sequence of three-dimensional maps over time of a control entity that is situated external to the computer system;
generating a three-dimensional representation of scene elements by driving a three-dimensional display with a second sequence of three-dimensional maps of scene elements;
correlating the first sequence with the second sequence in order to detect a spatial relationship between the control entity and the scene elements; and
controlling a computer application responsively to the spatial relationship.

2. The method according to claim 1, wherein the spatial relationship is an overlap of the control entity in a frame of the first sequence with one of the scene elements in frame of the second sequence wherein a control entity.

3. The method according to claim 1, wherein generating the three-dimensional representation comprises producing an image of the scene elements in free space.

4. The method according to claim 1, wherein generating the three-dimensional representation comprises extending a two-dimensional representation of the scene elements on a display screen to another representation having three perceived spatial dimensions.

5. A method of interfacing a computer system, comprising the steps of:
capturing a first sequence of three-dimensional maps over time of at least a part of a control entity;
generating a three-dimensional representation of scene elements by driving a three-dimensional display with a second sequence of three-dimensional maps of scene elements;
correlating the first sequence with the second sequence in order to detect a direction and speed of movement of the part of the control entity with respect to the scene elements; and
controlling a computer application responsively to the direction and speed of movement with respect to at least one of the scene elements.

6. The method according to claim 5, wherein controlling the computer application comprises updating at least a portion of the scene elements.

7. The method according to claim 5, wherein generating the three-dimensional representation comprises producing an image of the scene elements in free space.

8. The method according to claim 5, wherein generating the three-dimensional representation comprises extending a two-dimensional representation of the scene elements on a display screen to another representation having three perceived spatial dimensions.

9. The method according to claim 5, further comprising the steps of:
deriving a viewing distance of a human subject from the first sequence of three-dimensional maps; and
adjusting the second sequence of three-dimensional maps according to the viewing distance.

10. The method according to claim 5, further comprising the steps of:
deriving a viewing angle of a human subject from the first sequence of three-dimensional maps; and
adjusting the second sequence of three-dimensional maps according to the viewing angle.

11. A computer program product for interfacing a computer system, including a computer-readable storage medium in which computer program instructions are stored, which instructions, when executed by a computer, cause the computer to perform the steps of:
capturing a first sequence of three-dimensional maps over time of at least a part of a control entity;
generating a three-dimensional representation of scene elements by driving a three-dimensional display with a second sequence of three-dimensional maps of scene elements;
correlating the first sequence with the second sequence in order to detect a direction and speed of movement of the part of the control entity with respect to the scene elements; and
controlling a computer application responsively to the direction and speed of movement with respect to at least one of the scene elements.

12. The computer program product according to claim 11, wherein controlling the computer application comprises updating at least a portion of the scene elements.

13. The computer program product according to claim 11, wherein the three-dimensional maps of scene elements comprise interactive regions that include respective ones of the scene elements and controlling the computer application comprises detecting a motion of the part of the control entity within respective interactive regions.

14. The computer program product according to claim 11, further comprising the steps of:
deriving a viewing distance of a human subject from the first sequence of three-dimensional maps; and
adjusting the second sequence of three-dimensional maps according to the viewing distance.

15. The computer program product according to claim 11, further comprising the steps of:
deriving a viewing angle of a human subject from the first sequence of three-dimensional maps; and
adjusting the second sequence of three-dimensional maps according to the viewing angle.

16. A user interface apparatus, comprising:
a sensing device, which is configured to capture a first sequence of three-dimensional maps over time of at least a part of a control entity;
a three-dimensional display module, which is adapted for generating a three-dimensional representation of scene elements; and
a processor;
a memory accessible to the processor having a computer application stored therein, wherein the processor is configured to execute the computer application and cooperatively therewith perform the steps of:
constructing a second sequence of three-dimensional maps of scene elements;
driving the three-dimensional display module with the second sequence;
correlating the first sequence with the second sequence in order to detect a direction and speed of movement of the part of the control entity with respect to the scene elements; and
controlling the computer application responsively to the direction and speed of movement with respect to at least one of the scene elements.

17. The apparatus according to claim 16, wherein controlling the computer application comprises updating at least a portion of the scene elements.

18. The apparatus according to claim 16, wherein the three-dimensional maps of scene elements comprise interactive regions that include respective ones of the scene elements and controlling the computer application comprises detecting a motion of the part of the control entity within respective interactive regions.

19. The apparatus according to claim 16, wherein generating the three-dimensional representation comprises producing an image of the scene elements in free space.

20. The apparatus according to claim 16, wherein generating the three-dimensional representation comprises extending a two-dimensional representation of the scene elements on a display screen to another representation having three perceived spatial dimensions.
